(19) United States
(12) Patent Application Publication
(10) Pub. No.: US 2024/0027864 A1
(43) Pub. Date: Jan. 25, 2024

(54) PANE WITH A FUNCTIONAL ELEMENT HAVING ELECTRICALLY SWITCHABLE OPTICAL PROPERTIES AND PATTERN FOR HIGH-FREQUENCY TRANSMISSION

(71) Applicant: SAGE ELECTROCHROMICS, INC., FARIBAULT, MN (US)

(72) Inventors: Guillaume FRANCOIS, AACHEN (DE); Stefan DROSTE, HERZOGENRATH (DE)

(21) Appl. No.: 18/043,994

(22) PCT Filed: Aug. 17, 2021
(86) PCT No.: PCT/EP2021/072767

§ 371 Date: Mar. 3, 2023

(30) Foreign Application Priority Data
Sep. 18, 2020 (EP) 20196837.7

(51) Int. Cl. G02F 1/155; B32B 17/10

(52) U.S. Cl. CPC G02F 1/155; B32B 17/10036; B32B 17/1022; B32B 17/1099; B32B 17/10293; B32B 17/10348; B32B 17/10513; B32B 17/10761; B32B 2605/00; B32B 2419/00; B32B 2307/304; B32B 2307/204

(57) ABSTRACT

A pane with a functional element having electrically switchable optical properties, includes a first pane, a functional element having electrically switchable optical properties including a first surface electrode, an active layer, and a second surface electrode arranged flat one above the other in this order, a first busbar that electrically conductively contacts the first surface electrode and a second busbar that electrically conductively contacts the second surface electrode, a edge-side pattern in the edge region that is formed by decoated, linear regions within the first surface electrode and/or the second surface electrode such that the linear regions are situated adjacent the first busbar and/or second busbar and extend, starting from there, in the direction of the opposite section of the circumferential edge, wherein the edge-side pattern has no electrically isolated zones within the first and second surface electrodes.

The invention relates to a pane with a functional element having electrically switchable optical properties that has low transmission loss for electromagnetic radiation in the high-frequency range. The invention further relates to a method for producing such a pane and use thereof as well as an insulating glazing including such a pane.

Current glazings require a variety of technical devices for transmitting and receiving electromagnetic radiation for the operation of basic services such as radio reception, preferably in the AM, FM, or DAB bands, mobile telephony in the GSM 900 and DCS 1800, UMTS, LTE, and 5G bands as well as satellite-based navigation (GPS) and WLAN. In particular, in the field of automotive glazing, a variety of approaches are known for improving the transmission of electromagnetic radiation. However, in the wake of modern switchable building glazings, these problems are increasingly occurring in this field as well.

Modern glazings increasingly have, on all sides and over the entire surface, coatings that are electrically conductive and transparent to visible light. These transparent, electrically conductive coatings protect interiors, for example, against overheating from sunlight or cooling, by reflecting incident thermal radiation, as is known from EP 378917 A. Transparent, electrically conductive coatings can effect selective heating of the pane by applying an electrical voltage, as is known from WO 2010/043598 A1.

Common to the transparent, electrically conductive coatings is the fact that they are also impermeable to electromagnetic radiation in the high-frequency range. Due to glazing of a vehicle on all sides and over entire surfaces with transparent, electrically conductive coatings, the transmission and reception of electromagnetic radiation in the interior is no longer possible. For the operation of sensors such as rain sensors, camera systems, or stationary antennas, one or two localized regions of the electrically conductive, transparent coating are commonly decoated. These decoated regions form a so-called “communication window” or “data transmission window” and are known, for example, from EP 1 605 729 A2. Since the transparent, electrically conductive coatings affect the coloring and reflectivity of a pane, communication windows are visually quite conspicuous. Decoated regions can cause disturbances in the field of vision of the pane.

Known from EP 0 717 459 A1, US 2003/0080909 A1, and DE 198 17 712 C1 are panes with a metallic coating, all of which have grid-like decoating of the metallic coating. The grid-like decoating acts as a low-pass filter for incident high-frequency electromagnetic radiation. The grid spaces are small compared to the wavelength of the high-frequency electromagnetic radiation; and, thus, a relatively large proportion of the coating is patterned and through-vision is impaired to a greater extent. The removal of a larger share of the layer is time-consuming and costly.

US 2020/056423 A1 and US2018/307111 A1 describe insulating glazings including functional elements having electrically switchable optical properties.

WO 2015/091016 A1 discloses a pane with a transparent electrically conductive coating, into which decoated patterns are introduced, wherein the decoated patterns have the form of a full-surface decoated rectangle or a decoated rectangular frame.

Known from EP 2 586 610 A1 is a pane with electrically conductive coating as an infrared reflecting coating, wherein decoated lines are introduced into the coating.

US 2004/0113860 A1 discloses a glazing with a metallic layer that can be used as a heating layer or for reflecting infrared radiation, wherein openings intended to enable improved electromagnetic transmission are introduced into the layer.

The object of the present invention now consists in providing a pane having a functional element that has electrically switchable optical properties, which has improved transmission of high-frequency electromagnetic radiation with, at the same time, homogeneous switching behavior of the functional element and low impairment of through-vision, an insulating glazing including such a pane, a method for production thereof, and use thereof. These and other objects are accomplished according to the proposal of the invention by a pane with the features of the independent claims.

Advantageous embodiments of the invention are indicated by the features of the dependent claims. A method for production of a pane with high-frequency transmission as well as the use of such a pane emerge from further independent claims.

A pane according to the invention comprises at least one first pane having a first side, a second side, a circumferential edge, and an edge region adjacent the circumferential edge, wherein a functional element having electrically switchable optical properties is arranged flat on the first side of the first pane. The functional element comprises, arranged flat one above the other, at least a first surface electrode and a second surface electrode between which an active layer of the functional element is situated. An electrical voltage can be applied to the surface electrodes via a first busbar, which electrically conductively contacts the first surface electrode, and a second busbar, which electrically conductively contacts the second surface electrode. In the edge region of the pane, in the vicinity of the first busbar and/or in the vicinity of the second busbar, an edge-side pattern is introduced within the first surface electrode and/or the second surface electrode, with the edge-side pattern formed by decoated linear regions. The decoated linear regions are situated along the busbars between the edge of the busbar facing the center of the surface of the respective surface electrode and the center of the surface and extend, starting from there, in the direction of the opposite section of the circumferential edge of the pane. The linear decoated regions can take a large variety of courses and angles to the nearest busbar; in the course of a linear decoated region, the distance from the nearest busbar should only increase and the distance to the opposite section of the circumferential edge should only decrease. The edge-side pattern has no electrically isolated zones within the first surface electrode and the second surface electrode. Accordingly, the decoated linear regions within one of the surface electrodes do not completely enclose any surface region.

The invention enables designing a pane with a functional element having electrically switchable optical properties with good transmission for high-frequency electromagnetic radiation. Thus, large-area decoating of the surface electrodes can be avoided. In addition, the pattern formed by the decoated linear regions is arranged within the edge region of the pane such that through-vision through the pane is also not impaired or only slightly impaired. Furthermore, in practice, the busbars of the functional element are often concealed by an opaque masking print, whereby, advantageously, at least a subregion of the edge-side pattern is likewise concealed. The edge-side pattern of the pane also does not completely enclose any surface regions of the first surface electrode and the second surface electrode. As a result, no electrically isolated zones are created within the surface electrodes such that no regions with insufficient switching behavior of the functional element are created. Accordingly, a pane with good switching behavior of the functional element, good optical through-vision in the transparent state, and sufficient transmission for high-frequency electromagnetic radiation is obtained.

Preferably, the edge-side pattern is introduced in the edge region of the pane in the vicinity of the first busbar at least in the first surface electrode and/or in the vicinity of the second busbar at least in the second surface electrode.

The edge-side pattern extends in the edge regions in which a busbar is situated along the busbar, with the edge-side pattern preferably being introduced at least along 80% of the length of the nearest busbar, particularly preferably along 90% of the length of the nearest busbar, in particular along the entire length of the nearest busbar in the first surface electrode and/or the second surface electrode. The length of the busbar is defined here as the dimension of the busbar along the nearest section of the circumferential edge of the pane.

Preferably, edge-side patterns are introduced adjacent the first busbar and adjacent the second busbar, respectively.

Preferably, edge-side patterns are introduced both in the first surface electrode adjacent the first busbar and in the second surface electrode adjacent the first busbar. Preferably, edge-side patterns are likewise introduced in the vicinity of the second busbar in the second surface electrode and in the vicinity of the second busbar in the first surface electrode. Thus, in the vicinity of a busbar, both surface electrodes are preferably provided with the edge-side pattern. This is advantageous for achieving good permeability of both surface electrodes for high-frequency electromagnetic radiation in these regions. The radiation transmitted at a first surface electrode is thus also transmitted at the second surface electrode. The edge-side patterns of the first surface electrode and the second surface electrode located within a common edge region can be designed differently or also identically. Even when the edge-side patterns are designed identically, they can be arranged substantially congruently or even offset relative to one another.

Preferably, the busbars of different polarities are arranged at opposite sections of the circumferential edge of the pane. As a result, homogeneous flow of current and uniform switching behavior of the functional element are achieved. The decoated linear regions extending in the direction of the opposite edge form current paths between adjacent lines. Preferably, edge-side patterns extend in each case starting from the first busbar and starting from the second busbar in the direction of the respective opposite edge. The edge-side pattern is preferably placed along the entire edge section of the circumferential edge where the associated busbar is situated. In this way, on the one hand, the transmission of electromagnetic radiation through the pane can be increased; and, on the other, the flow of current via the surface electrodes can be directed by means of the current paths formed between decoated linear regions. The edge sections of the circumferential edge where no busbars are arranged are preferably not provided with an edge-side pattern comprising decoated linear regions in order to avoid disturbances of the flow of current along the surface electrodes and an associated inhomogeneous switching behavior of the functional element. Optionally, however, even edge sections of the circumferential edge that have no busbars and no edge-side pattern can be provided with different patterning of the surface electrodes. In particular, along the edge sections of the pane where no busbars run, surface decoating of the surface electrodes can be provided in the edge region. This is done only in the region of the pane in which switchability of the functional element can be dispensed with, for example, outside the through-vision region of the pane. In this way, the transmission of electromagnetic radiation can be further increased.

The transmission of high-frequency electromagnetic radiation through the pane according to the invention is based on the principle that certain frequency ranges of electromagnetic radiation are amplified on the grid formed by the edge-side pattern. The smaller the distance between adjacent decoated linear regions, the more the transmission of high frequencies is preferred, whereas with greater distances between lines, the lower frequencies of the high-frequency electromagnetic radiation are transmitted amplified. Moreover, the orientation of the decoated linear regions relative to the field vector of the incident electromagnetic radiation is decisive for its transmission. The distance between the decoated linear regions is a determining factor for the permeability of electromagnetic radiation of certain wavelengths, such as radiation for the operation of mobile telephony in the GSM 900 and DCS 1800, UMTS, LTE, and 5G bands as well as satellite-based navigation (GNSS) and other ISM frequencies, such as WLAN, Bluetooth, or CB radio. On the other hand, the pattern according to the invention allows further variations through the orientation of the decoated lines and through intersection regions with other lines that are optionally present. In this way, it is easily possible to achieve optimization of transmissivity even simultaneously for multiple frequency bands. The edge-side patterns according to the invention act as low-pass filters, in other words, they can be optimized to a cutoff frequency at which frequencies lower than the cutoff frequency are allowed to pass and above which the transmission of frequencies higher than the cutoff frequency becomes poorer. In a manner generally known to the person skilled in the art, the selection of the cutoff frequency determines the spacing of the decoated lines that form the grid pattern. The electromagnetic transmission is influenced by them such that the smaller the maximum distance between the lines, the higher the cutoff frequency up to which the transmission remains unaffected. If, for example, in the vertical direction, the maximum distance is 2.0 mm and in the horizontal direction is 5.0 mm between the decoated regions, the resultant cutoff wavelength can be estimated to be up to 20 times these values. For the relevant correlations and estimates, reference is made to the description of DE 195 08 042 A1. In principle, however, any polarization can be transmitted.

In a preferred embodiment, the decoated linear regions are implemented as straight lines that extend at an angle of, for example, 15° to 90° relative to the nearest busbar in the direction of the opposite section of the circumferential edge. When determining the angle between a decoated linear region and the nearest busbar, the acute angle is considered. The transmission of the electromagnetic radiation is determined by the relative arrangement of the decoated linear regions and the polarization direction of the electrical field vector of the incident radiation. Radiation with a polarization direction parallel to the decoated linear regions is transmitted only slightly, while the radiation with a polarization direction perpendicular thereto is transmitted. As for the polarization directions between those, in each case, primarily only the component with a polarization direction perpendicular to the linear regions is transmitted. In order to achieve sufficient overall transmission, now, for example, one polarization direction can be ignored, while in the direction perpendicular thereto, maximum transmission is achieved. In this context, in a preferred embodiment, the decoated linear regions are oriented at an angle of 90° relative to the respective nearest busbar.

In another preferred embodiment, the decoated linear regions have a wavy shape or substantially wavy shape. “Substantially wavy” refers, for example, to a shape formed from multiple contacting straight-line sections that can be roughly described by means of a wave function. The substantially wavy shape thus deviates only insignificantly from the shape to be described by means of a wave function, while retaining the overall impression of a wave shape. In the context of the present invention, the term “sinusoidal shape” means, in particular, that the lines of the linear regions have a curvature or, in each case, in their course, different curvatures alternating at least in some sections. The curvature or curvatures of the decoated regions can run both with a constant angle of curvature and with a variable angle of curvature. In particular, the term includes both curved linear regions with a “perfect” sinusoidal shape and curved linear regions with non-“perfect” sinusoidal shape, in other words, with any waveform. Particularly preferred is a sinusoidal course and/or a zigzag course at least in some sections of the decoated linear regions of the edge-side pattern. Such a wavy or zigzag course with the associated change in direction of the decoated linear regions is responsible for improved transmission of both polarization directions perpendicular to one another. A sinusoidal course has proved to be particularly advantageous in terms of the proportion of radiation transmitted. Sinusoidal or any wavy patterns are also less disturbing in appearance for an observer than rectilinear patterns. This is due in particular to the fact that with a sinusoidal or wavy pattern, there are fewer corners, in particular fewer right-angled or even acute-angled corners in the pattern. Although a wavy course of the decoated linear regions is very advantageous in terms of transmission, the influence of such an edge-side pattern on the flow of current along the surface electrodes must be taken into account. In particular, in the case of a large amplitude in the wavy course and/or if the decoated wavy regions run for a relatively long distance in the edge region, the length of the current paths introduced into the surface electrodes is increased. This results in increased electrical resistance and the associated voltage drop.

According to a preferred embodiment, the decoated linear regions of the edge-side pattern have a rectilinear course or a substantially rectilinear course. This is advantageous in terms of the shortest possible distance of the current paths created between adjacent decoated linear regions. A substantially rectilinear course deviates only insignificantly from a straight line, with, in this context, in the case of a substantially rectilinear course, the preferred direction of the straight line substantially describing the course is maintained in the case of a substantially rectilinear course. Preferably, the decoated linear regions assume an angle of 10° to 50°, particularly preferably 20° to 45°, in particular 25° to 40° relative to the adjacent first busbar or second busbar. In this case, the acute angle between the decoated linear region and the busbar is considered. Within these regions, it is possible both to achieve advantageously high transmission and to avoid an undesirably large voltage drop in the region of the edge-side pattern.

The decoated linear regions of an edge-side pattern can assume the same angle or different angles within the preferred ranges relative to the adjacent busbar. In a possible embodiment, the decoated linear regions run parallel to one another. In another possible embodiment, the edge-side pattern has at least two groups of decoated linear regions, whose group members run parallel to one another. A first section of the edge region of the first surface electrode has, in the vicinity of the first busbar, at least one group of first decoated linear regions, which run substantially parallel to one another. A second section of the edge region of the first surface electrode, adjacent the first section, has at least one second group of decoated linear regions, likewise running substantially parallel to one another. The first group of the decoated linear regions and the second group of the decoated linear regions assume an angle of 10° to 100°, preferably 40° to 90° to one another. The second surface electrode can, analogously, also have at least two groups of decoated linear regions that are not parallel to one another. At least two groups of decoated linear regions, whose course is not parallel to one another, are advantageous for improving the transmission of electromagnetic radiation of different polarization directions. In a particularly preferred embodiment, the magnitude of the angle that the first group of linear regions and the second group of linear regions assume in each case relative to the nearest busbar, is equal or approx. equal. Thus, the desired different orientation of the groups of decoated linear regions can be achieved and, at the same time, the most advantageous angle of the lines for the course of the current paths can be selected.

Preferably, the line density of the decoated linear regions of the edge-side pattern within the edge region increases in the direction of the circumferential edge. Accordingly, decoated linear regions of different lengths are introduced into the edge region. Some of the decoated linear regions have a greater length than the decoated linear regions adjacent thereto and extend by a greater amount in the direction of the opposite edge. This creates an alternating arrangement of one or more decoated linear regions of greater length with one or more decoated linear regions of lesser length. The linear regions of greater length are adjacent only similar regions of greater length on the edge of the edge-side pattern facing away from the busbar; the linear regions of lesser length do not protrude correspondingly far in the direction of the center of the surface. In this way, a section of the edge-side pattern with higher line density of the decoated regions is formed in the vicinity of the nearest busbar, whereas there is a greater distance between lines and thus lower line density at the edge of the edge-side pattern facing away from the busbar. The frequency of the transmitted wavelengths depends on the distance between adjacent linear regions, with the region of higher line density advantageous for the transmission of higher frequencies, and in the region of lesser line density, primarily lower frequencies of the high-frequency electromagnetic radiation are transmitted. Thus, this embodiment is advantageous for achieving good transmission of the large variety of frequencies of the spectrum. Optionally, the region of higher line density can be limited to the region bearing an opaque masking print in order not to adversely affect the optical appearance of the pane.

Preferably, the first surface electrode and/or the second surface electrode has in each case a group of decoated linear regions that are parallel or substantially parallel to linear regions of the same group. Preferably, the distance between adjacent decoated linear regions of the same group is 1.0 mm to 20.0 mm, preferably 1.0 mm to 10.0 mm, particularly preferably 2.0 mm to 5.0 mm. Advantageous transmission of high-frequency electromagnetic radiation occurs within these regions.

In all the embodiments described, further decoated linear regions can be introduced in the surface electrodes in addition to the decoated linear regions mentioned. These can also assume angles relative to the busbars other than those described. For example, the further decoated linear regions and the decoated linear regions can also intersect. In a preferred embodiment, decoated linear regions intersect other decoated linear regions at an angle of 90°, with further decoated linear regions attached at the four ends of the cross-shaped arrangement, which regions run perpendicular in each case to the line at the end of which they are attached. Care must be taken here that the terminal lines that are attached at the ends of the cross-shaped arrangement do not intersect with each other. The formation of electrically isolated zones within the edge-side pattern is thus avoided. The cross-shaped arrangement of decoated linear regions with terminal decoated linear regions at the ends of the intersecting lines encloses an arrangement of four rectangles, two of which are situated next to each other and two of which are situated one above the other. The four rectangles outlined by the decoated linear regions form, together, a large rectangle at the corners of which the decoated linear regions are cut out, i.e., there is no decoating. Via this region, the surface portions of the surface electrodes that are situated within the rectangles are electrically conductively connected to the surrounding surface electrode such that there are no electrically isolated zones within the edge-side pattern. Preferably, a plurality of these cross-shaped arrangements are introduced next to one another along the first busbar and/or second busbar within the first surface electrode or the second surface electrode. Such an edge-side pattern achieves both good transmission of different polarization directions of the electrical field vector and good transmission of various frequencies and little impairment of the switching behavior of the functional element in the through-vision region of the pane. Preferably, the length of the intersecting decoated linear regions is in each case 10 mm to 40 mm, preferably 20 mm to 30 mm, while the length of the terminal linear regions is 8 mm to 30 mm, preferably 15 mm to 25 mm. The distance between adjacent cross-shaped arrangements is determined as the smallest distance between two lines of adjacent arrangements and is 1.0 mm to 5.0 mm, for example, 2.0 mm. In these ranges, good results in terms of transmission could be achieved.

Optionally, the pane according to the invention additionally has at least one central pattern, which is also arranged outside the edge region at least in sub-regions of the pane. The central pattern is introduced into the first surface electrode and/or second surface electrode and has in each case no electrically isolated zones within the first surface electrode and the second surface electrode. The central pattern thus does not completely enclose any areas within the first surface electrode and the second surface electrode. If a central pattern is provided, it is usually introduced into both surface electrodes. In this way, transmission occurs equally through both surface electrodes. The first surface electrode and the second surface electrode can have different or identical central patterns, which are, optionally, arranged congruently or offset relative to one another.

Preferably, the at least one central pattern comprises decoated linear regions. Preferably, the decoated linear regions of the central pattern extend within the first surface electrode starting from the edge-side pattern in the vicinity of the first busbar in the direction of the second busbar, and/or the decoated linear regions of the central pattern run within the second surface electrode starting from the edge-side pattern in the vicinity of the second busbar in the direction of the first busbar. In particular, central patterns in the form of decoated linear regions are preferred in both surface electrodes. A course of the decoated linear regions starting from one busbar in the direction of the busbar with opposite polarity enables, on the one hand, transmission in the through-vision region of the pane, while, on the other, good switchability of the functional element is maintained. The current paths created between the decoated linear regions are decisive for the good switchability of the functional element.

The first and the second busbars can also be attached to a plurality of side edges of the pane, with the pane preferably having a rectangular contour. The circumferential edge comprises four rectilinear edge sections, of which two are opposite one another in each case. In a preferred embodiment, the first busbar extends along two adjacent edge sections, with the second busbar likewise extending along the edge sections opposite these. Thus, the first busbar and the second busbar run in each case along two adjacent edge sections of the circumferential edge. The contact surface between the busbar and the surface electrode electrically contacted therewith is increased, and the distance the current must run via the surface electrode is minimized. Accordingly, improved switchability with more homogeneous switching behavior can be achieved. In principle, the edge-side patterns can assume all the aforementioned patterns and courses. For example, the decoated linear regions can have an angle of 90° relative to the nearest section of the busbar, with a gradual transition between two orientations of the decoated linear regions occurring in the overlapping corner region in which a busbar comprises two adjacent edge sections. In another preferred embodiment, the edge-side patterns are implemented as decoated linear regions that extend at an angle of 10° to 50°, particularly preferably 20° to 45°, in particular 25° to 40° relative to the adjacent section of the nearest busbar. Here, the acute angle between decoated linear regions and busbars is considered. Particularly preferably, the angle of the decoated linear regions relative to the nearest section of the adjacent busbar is variable. Preferably, there is a gradual transition between decoated linear regions with an angle of 90° relative to the nearest section of the adjacent busbar and decoated linear regions with an angle of 45° relative to the nearest section of the adjacent busbar. An angle of 45° is achieved in the corner of the pane spanned by the associated busbar, whereas there are angles of 90° in the region of the center of the edge. In this way, all polarization directions of the electrical field vector can be transmitted equally, and a homogeneous visual appearance can be achieved. With a variable angle, the decoated linear regions can have a constant length or even an increasing length from the center of the edge to the corner. A constant length is advantageous for keeping the regions to be decoated and the associated production effort as low as possible. If a length increasing from the center of the edge to the corner is selected, the decoated linear regions can be implemented such that their ends pointing away from the associated busbar are located at a constant distance from the nearest section of the circumferential edge, thus achieving a particularly attractive visual appearance.

In addition to the aforementioned required or optional patterns of the decoated linear regions, electrically isolated zones can also be provided in the edge region along the sections of the circumferential edge where no busbars are arranged. These electrically isolated zones are provided within the first surface electrode and/or the second surface electrode, preferably within both surface electrodes. In the edge region of the pane that includes electrically isolated zones, the functional element can no longer be switched. In the edge region, the surface electrodes can, for example, be completely decoated or also be provided with a patterning of linear decoated regions that includes portions of the surface electrodes. This creates electrically isolated zones that are not electrically contacted with the busbars. Within these electrically isolated zones, patterning can be done without regard to the flow of current along the surface electrodes. In the installed position of the pane, for example, in an insulating glazing, the electrically isolated zones are preferably located outside the vision area and/or are, for example, concealed by an opaque masking print. According to the invention, such electrically isolated zones are excluded along the busbars adjacent them in order to enable homogeneous switchability of the functional element in the through-vision region.

The functional element having electrically switchable optical properties can be implemented as an electrochromic functional element, an SPD element, a PDLC element, or an electroluminescent element. Particularly preferably, the functional element is an electrochromic functional element.

An electrochromic functional element includes at least one electrochemically active layer that is capable of reversibly storing charges. The oxidation states in the stored and released state differ in their coloration, with one of these states being transparent. The storage reaction can be controlled via the externally applied potential difference. The basic structure of the electrochromic functional element thus comprises at least one electrochromic material, such as tungsten oxide, which makes contact with both a surface electrode and a charge source, such as an ion-conductive electrolyte. In addition, the electrochromic layer structure contains a counter electrode, which is likewise capable of reversibly storing cations and is in contact with the ion-conductive electrolyte, as well as another surface electrode, which is connected to the counter electrode. The surface electrodes are connected to an external voltage source by which the voltage applied to the active layer can be regulated. The surface electrodes are usually thin layers of electrically conductive materials, often indium tin oxide (ITO). Often, at least one of the surface electrodes is applied directly on the surface of the first pane, for example, by cathodic sputtering.

Other possible functional elements differ therefrom essentially by the type of active layer positioned between the surface electrodes. In other possible embodiments, the active layer is an SPD layer, a PDLC layer, an electrochromic layer, or an electroluminescent layer.

An SPD functional element (suspended particle device) contains an active layer comprising suspended particles, wherein the absorption of light by the active layer can be changed by applying a voltage to the surface electrodes. The change in absorption is based on the orientation of the rod-like particles in the electrical field when electric voltage is applied. SPD functional elements are known, for example, from EP 0876608 B1 and WO 2011033313 A1.

In a possible embodiment, the functional element is a PDLC functional element (polymer dispersed liquid crystal). The active layer of a PDLC functional element contains liquid crystals that are embedded in a polymer matrix. When no voltage is applied to the surface electrodes, the liquid crystals are oriented in a disorderly manner, resulting in strong scattering of the light passing through the active layer. When a voltage is applied to the surface electrodes, the liquid crystals align themselves in a common direction and the transmittance of light through the active layer is increased. Such a functional element is known, for example, from DE 102008026339 A1.

In electroluminescent functional elements, the active layer contains electroluminescent materials, in particular organic electroluminescent materials whose luminescence is stimulated by the application of a voltage. Electroluminescent functional elements are known, for example, from US 2004227462 A1 and WO 2010112789 A2. The electroluminescent functional element can be used as a simple light source or as a display with which any displays can be shown.

In principle, any type of transparent electrically conductive coating is known as the first surface electrode and the second surface electrode. The first and/or the second surface electrode include at least one metal, preferably silver, nickel, chromium, niobium, tin, titanium, copper, palladium, zinc, gold, cadmium, aluminum, silicon, tungsten, or alloys thereof, and/or at least one metal oxide layer, preferably tin-doped indium oxide (ITO), aluminum-doped zinc oxide (AZO), fluorine-doped tin oxide (FTO, SnO₂:F), antimony-doped tin oxide (ATO, SnO₂:Sb), and/or carbon nanotubes and/or optically transparent, electrically conductive polymers, preferably poly(3,4-ethylene dioxythiophenes), polystyrene sulfonate, poly(4,4-dioctyl-cylopentadithiophene), 2,3-dichloro-5,6-dicyano-1,4-benzoquinone, mixtures, and/or copolymers thereof.

The thickness of the surface electrodes can vary widely and be adapted to the requirements of the individual case. It is essential here that the thickness of the transparent, electrically conductive coating must not be so great that it becomes impermeable to electromagnetic radiation, preferably electromagnetic radiation with a wavelength of 300 to 1300 nm, and in particular visible light. The transparent, electrically conductive coating preferably has a layer thickness of 10 nm to 5 μm and particularly preferably of 30 nm to 1 μm.

The linear decoated regions introduced into the first and/or second surface electrode have a line width of the decoated regions of 5 μm to 500 μm in each case and preferably of 10 μm to 140 μm in each case. Within these line widths, the switching operation of the functional element is not visibly impaired. Furthermore, these line widths can be introduced in a simple manner with commercially available lasers.

The surface electrodes of the functional element are electrically conductively contacted via so-called busbars and are connected via the busbars to an electrical supply line that is connected to an external power source. For example, strips of an electrically conductive material or electrically conductive imprints can be used as busbars, with which the surface electrodes are connected. The busbars are used to transmit electrical power and enable homogeneous voltage distribution. The busbar are advantageously produced by printing a conductive paste. The conductive paste preferably contains silver particles and glass frits. The layer thickness of the conductive paste is preferably from 5 μm to 20 μm.

In an alternative embodiment, thin and narrow metal foil strips or metal wires are used as busbars, preferably containing copper and/or aluminum; in particular, copper foil strips with a thickness of, for example, about 50 μm are used. The width of the copper foil strips is preferably 1 mm to 10 mm. The electrical contact between an electrically conductive layer of the functional element serving as a surface electrode and the busbar can, for example, be established by soldering or gluing with an electrically conductive adhesive.

The electrical supply line, used for contacting busbars with an external voltage source is an electrical conductor, preferably containing copper. Other electrically conductive materials can also be used. Examples include aluminum, gold, silver, or tin and alloys thereof. The electrical supply line can be designed either as a flat conductor or a round conductor and, in both cases, as a single-wire or multiwire conductor (stranded).

The electrical supply line preferably has a conductor cross-section of 0.08 mm² to 2.5 mm².

Foil conductors can also be used as the supply line. Examples of foil conductors are described in DE 42 35 063 A1, DE 20 2004 019 286 U1, and DE 93 13 394 U1.

Flexible foil conductors, also called flat conductors or ribbon conductors, preferably consist of a tinned copper strip with a thickness of 0.03 mm to 0.1 mm and a width of 2 mm to 16 mm. Copper has proved itself for such conductor tracks since it has good electrical conductivity as well as good processability into foils. At the same time, the material costs are low.

The invention further includes an insulating glazing comprising the pane with a functional element according to the invention, a second pane, and a circumferential spacer frame connecting the pane to the second pane. At least one electrically conductive coating is arranged flat on the second pane, with at least one edge-side pattern introduced into the edge region in the electrically conductive coating. The edge region of the second pane is the region adjacent the circumferential edge of the second pane. The edge-side pattern is provided in particular in regions in whose projection onto the pane having a functional element there is already an edge-side pattern of the pane. The edge-side pattern of the second pane can, in principle, assume all patterns explained for the edge-side pattern of the first pane. The edge-side patterns situated on the first pane and the second pane can be designed identically or differently, whereby, in the case of identical patterns, they can be arranged congruently or offset.

The electrically conductive coating of the second pane as well as the functional element situated on the first pane are attached to the pane surfaces facing the spacer and are thus situated in the inner interpane space of the insulating glazing, where they are protected against environmental influences.

Preferably, the electrically conductive coating of the second pane is an infrared reflecting coating. The infrared reflecting coating reduces the heat transfer through the insulating glazing such that heat loss can be avoided in the winter. In the summer, on the other hand, the infrared reflecting coating prevents heating of the interior due to incoming solar radiation. In particular, in combination with the electrochromic functional element, the use of an infrared reflecting coating is advantageous since, in this way, heat transfer of the waste heat of the functional element is also avoided.

The infrared reflecting coating is preferably transparent to visible light in the wavelength range from 390 nm to 780 nm. “Transparent” means that the total transmittance of the pane, in particular for visible light is preferably >70% and in particular >75%. As a result, the visual impression of the glazing and through-vision are not impaired.

The infrared reflecting coating is used for sun protection and, for this purpose, has reflecting properties in the infrared range of the light spectrum. The infrared reflecting coating has particularly low emissivity (low-E). As a result, the heating up of the interior of a building as a result of solar radiation is advantageously reduced. Panes provided with such an infrared reflecting coating are commercially available and are referred to as low-E (low emissivity) glass.

Low-E coatings usually contain a diffusion barrier, a metal- or metal-oxide-containing multilayer, and a barrier layer. The diffusion barrier is applied directly on the glass surface and prevents discoloration due to diffusion of metal atoms into the glass. Double silver layers or triple silver layers are often used as a multilayer. A wide variety of Low-E coatings are known, for example, from DE 10 2009 006 062 A1, WO 2007/101964 A1, EP 0 912 455 B1, DE 199 27 683 C1, EP 1 218 307 B1, and EP 1 917 222 B1.

Low-E coatings are preferably deposited using the method of magnetron-enhanced cathodic sputtering known per se. Layers deposited by magnetron-enhanced cathodic sputtering have an amorphous structure and cause hazing of transparent substrates such as glass or transparent polymers. A temperature treatment of the amorphous layers causes a crystal structure change to a crystalline layer with improved transmittance. The temperature input into the coating can be done by flame treatment, plasma torch, infrared radiation, or laser treatment.

Such coatings typically contain at least one metal, in particular silver or a silver-containing alloy. The infrared reflecting coating can include a sequence of multiple individual layers, in particular at least one metallic layer and dielectric layers containing, for example, at least a metal oxide. The metal oxide preferably contains zinc oxide, tin oxide, indium oxide, titanium oxide, silicon oxide, aluminum oxide, or the like as well as combinations of one or a plurality thereof. The dielectric material can also contain silicon nitride, silicon carbide, or aluminum nitride.

Particularly suitable transparent, infrared reflecting coatings contain at least one metal, preferably silver, nickel, chromium, niobium, tin, titanium, copper, palladium, zinc, gold, cadmium, aluminum, silicon, tungsten, or alloys thereof, and/or at least one metal oxide layer, preferably tin-doped indium oxide (ITO), aluminum-doped zinc oxide (AZO), fluorine-doped tin oxide (FTO, SnO₂:F), antimony-doped tin oxide (ATO, SnO₂:Sb), and/or carbon nanotubes and/or optically transparent, electrically conductive polymers, preferably poly(3,4-ethylene dioxythiophenes), polystyrene sulfonate, poly(4,4-dioctyl-cylopentadithiophene), 2,3-dichloro-5,6-dicyano-1,4-benzoquinone, mixtures, and/or copolymers thereof.

The infrared reflecting coating preferably has a layer thickness of 10 nm to 5 μm and particularly preferably of 30 nm to 1 μm. The sheet resistance of the infrared reflecting coating is, for example, 0.35 ohm/square to 200 ohm/square, preferably 0.6 ohm/square to 30 ohm/square, and in particular 2 ohm/square to 20 ohm/square.

In one possible embodiment, a silver layer with a thickness of 6 nm to 15 nm surrounded by two barrier layers with a thickness of 0.5 nm to 2 nm containing nickel-chromium and/or titanium is used as the infrared reflecting coating. A diffusion barrier with a thickness of 25 nm to 35 nm containing SiaN₄, TiO₂, SnZnO, and/or ZnO is preferably applied between one barrier layer and the glass surface. A diffusion barrier with a thickness of 35 nm to 45 nm containing ZnO and/or SiaN₄ is preferably applied to the upper barrier layer facing the environment. This upper diffusion barrier is optionally provided with a protective layer with a thickness of 1 nm to 5 nm comprising TiO₂ and/or SnZnO₂. The total thickness of all layers is preferably 67.5 nm to 102 nm.

The spacer is generally arranged circumferentially on the panes. The first and the second busbars preferably run parallel to the spacer in the first glazing interior, preferably on two opposite pane edges of the first pane.

The spacer is, in plan view, usually in the form of a rectangle. Normally, the spacer is symmetrical. i.e., it is the same distance from the edge of the insulating glazing on all sides of the insulating glazing.

The insulating glazing comprises at least two panes that are kept at a distance from one another by a spacer. The insulating glazing can also include a third or additional panes. These can, for example, be attached to the pane or second pane via additional spacers.

In a preferred embodiment, the first pane of the insulating glazing, which has the functional element, is laminated to another pane via a thermoplastic bonding film to form a composite pane. The composite pane has improved resistivity and stability. The third pane laminated to the first pane also impedes deflection and thermal expansion of the first pane. Furthermore, a composite pane has improved penetration resistance. In particular, this is advantageous for protecting the functional element.

Suitable thermoplastic bonding films are known to the person skilled in the art. The thermoplastic bonding films contain at least one thermoplastic polymer, preferably ethylene vinylacetate (EVA), polyvinyl butyral (PVB), or polyurethane (PU) or mixtures or copolymers or derivatives thereof. The thickness of the thermoplastic bonding films is preferably from 0.2 mm to 2 mm, particularly preferably from 0.3 mm to 1.5 mm. Polyvinyl butyral in a thickness of, for example, 0.38 mm or 0.76 mm is particularly preferably used for lamination of two glass panes.

The spacer of the insulating glazing preferably comprises at least one main body comprising two pane contact surfaces, a glazing interior surface, an outer surface, and a cavity.

The first and the second pane are attached to the pane contact surfaces preferably via a sealant that is attached between the first pane contact surface and the pane and/or the second pane contact surface and the second pane.

The sealant preferably contains butyl rubber, polyisobutylene, polyethylene vinyl alcohol, ethylene vinyl acetate, polyolefin rubber, copolymers and/or mixtures thereof.

The sealant is preferably introduced into the gap between the spacer and the panes with a thickness of 0.1 mm to 0.8 mm, particularly preferably 0.2 mm to 0.4 mm.

The first pane contact surface and the second pane contact surface constitute the sides of the spacer on which the outer panes (pane and second pane) of an insulating glazing are mounted when the spacer is installed. The first pane contact surface and the second pane contact surface run parallel to one another.

The glazing interior surface is defined as the surface of the spacer main body that faces in the direction of the interior of the glazing after the spacer is installed in an insulating glazing. The glazing interior surface is located between the panes.

The outer surface of the spacer main body is the side opposite the glazing interior surface, which faces away from the interior of the insulating glazing in the direction of an outer seal.

In a possible embodiment, the outer surface of the spacer can be angled in each case adjacent the pane contact surfaces, thus achieving increased stability of the main body. The outer surface can be angled adjacent the pane contact surfaces, for example, by 30-60° relative to the outer surface each case.

The cavity of the main body is adjacent the glazing interior surface, with the glazing interior surface situated above the cavity and the outer surface of the spacer is situated below the cavity. In this context, “above” is defined as facing the inner interpane space of the insulating glazing in the installed state of the spacer in an insulating glazing; “below”, as facing away from the pane interior.

The cavity of the spacer results in a weight reduction compared to a solidly formed spacer and is available to accommodate additional components, such as a desiccant.

The outer interpane space of the insulating glazing is preferably filled with an outer seal. This outer seal is used primarily to bond the two panes and thus for the mechanical stability of the insulating glazing.

The outer seal preferably contains polysulfides, silicones, silicone rubber, polyurethanes, polyacrylates, copolymers and/or mixtures thereof. Such substances have good adhesion to glass such that the outer seal ensures secure bonding of the panes. The thickness of the outer seal is preferably 2 mm to 30 mm, particularly preferably 5 mm to 10 mm.

The panes of the insulating glazing can be made of organic glass or preferably of inorganic glass. In an advantageous embodiment of the insulating glazing according to the invention, the panes can, independently of one another, be made of flat glass, float glass, soda lime glass, quartz glass, or borosilicate glass. The thickness of each pane can vary and thus be adapted to the requirements of the individual case. Preferably, panes with standard thicknesses from 1 mm to 19 mm and preferably from 2 mm to 8 mm are used. The panes can be colorless or colored.

The glazing interior can be filled with air or another gas, in particular an inert gas, such as argon or krypton. The glazing interior surface of the spacer faces the glazing interior.

The outer interpane space is also formed by the first pane, the second pane, the spacer, and the sealant placed between the panes and the pane contact surfaces and is situated opposite the glazing interior in the outer edge region of the insulating glazing. The outer interpane space is open on the side opposite the spacer. The outer surface of the spacer faces the outer interpane space.

The main body of the spacer can have a large variety of metallic or polymeric embodiments known to the person skilled in the art. Suitable metals are, in particular, aluminum or stainless-steel. Polymeric main bodies preferably contain polyethylene (PE), polycarbonates (PC), polypropylene (PP), polystyrene, polybutadiene, polynitriles, polyesters, polyurethanes, polymethyl methacrylates, polyacrylates, polyamides, polyethylene terephthalate (PET), polybutylene terephthalate (PBT), preferably acrylonitrile-butadiene-styrene (ABS), acrylonitrile-styrene-acrylester (ASA), acrylonitrile-butadiene-styrene/polycarbonate (ABS/PC), styrene-acrylonitrile (SAN), PET/PC, PBT/PC, and/or copolymers or mixtures thereof. Preferably, the polymeric main body is glass fiber reinforced. The main body preferably has a glass fiber content of from 20% to 50%, particularly preferably from 30% to 40%. The glass fiber content in the polymeric main body simultaneously improves strength and stability.

In a preferred embodiment, the spacer contains a desiccant, preferably silica gels, molecular sieves, CaCl2, Na2SO4, activated carbon, silicates, bentonites, zeolites, and/or mixtures thereof.

The spacer can preferably have one or a plurality of cavities. The cavity preferably contains the desiccant. The glazing interior surface preferably has openings to facilitate the absorption of atmospheric moisture by the desiccant present in the spacer. The total number of openings depends on the size of the insulating glazing. The openings connect the cavity to the inner interpane space, enabling a gas exchange between them. This allows atmospheric moisture to be absorbed by the desiccant situated in the cavity and thus prevents fogging of the panes. The openings are preferably implemented as slits, particularly preferably as slits with a width of 0.2 mm and a length of 2 mm. The slits ensure optimum air exchange without allowing desiccant to penetrate from the cavity into the glazing interior.

When polymeric main bodies are used, a gas- and vapor-tight barrier is preferably applied at least on the outer surface of the polymeric main body. The gas- and vapor-tight barrier improves the tightness of the spacer against gas loss and moisture penetration. Preferably, the barrier is applied to approx. one-half to two-thirds of the pane contact surfaces. A suitable spacer with a polymeric main body is disclosed, for example, in WO 2013/104507 A1.

The invention further relates to a method for producing a pane according to the invention, wherein at least:
a. a first pane with a functional element having electrically switchable optical properties is provided, and
b. at least one edge-side pattern comprising decoated, linear regions is formed within the first surface electrode and/or the second surface electrode such that the linear regions are situated adjacent the first busbar and/or second busbar and extend, starting from there, in the direction of the opposite section of the circumferential edge,
wherein the edge-side pattern has no electrically isolated zones within the first surface electrode and the second surface electrode.

The decoating of the edge-side patterns in the first and/or second surface electrode is preferably done by a laser beam. Methods for patterning thin metal foils are known, for example, from EP 2 200 097 A 1 or EP 2 139 049 A 1. The width of the decoating is preferably from 5 μm to 150 μm, particularly preferably from 5 μm to 100 μm, most particularly preferably from 10 μm to 50 μm, and in particular from 15 μm to 30 μm. In this range, particularly clean and residue-free decoating by the laser beam takes place. Decoating by laser beam is particularly advantageous since the decoated lines are visually quite inconspicuous and have very little adverse effect on appearance and transparency. The decoating of a line of width d, which is wider than the width of a laser cut, is carried out by repeatedly scanning the line with the laser beam. Process duration and process costs therefore increase with increasing line width.

In an advantageous embodiment of the method according to the invention, the decoated pattern is introduced by laser patterning in the first and/or second surface electrode. The laser beam can be focused through the pane and/or any carrier films of the functional element onto the first and/or second surface electrode.

The invention further extends to the use of a pane as described above or a corresponding insulating glazing as a glazing with low transmission loss for high-frequency electromagnetic radiation, in a vehicle body or a vehicle door of a means of transport on land, on water, or in the air, preferably as a windshield, in buildings as part of an external façade or a building window.

The invention is explained in detail in the following with reference to drawings and an example. The drawings are not completely to scale. The invention is in no way restricted by the drawings. They depict:

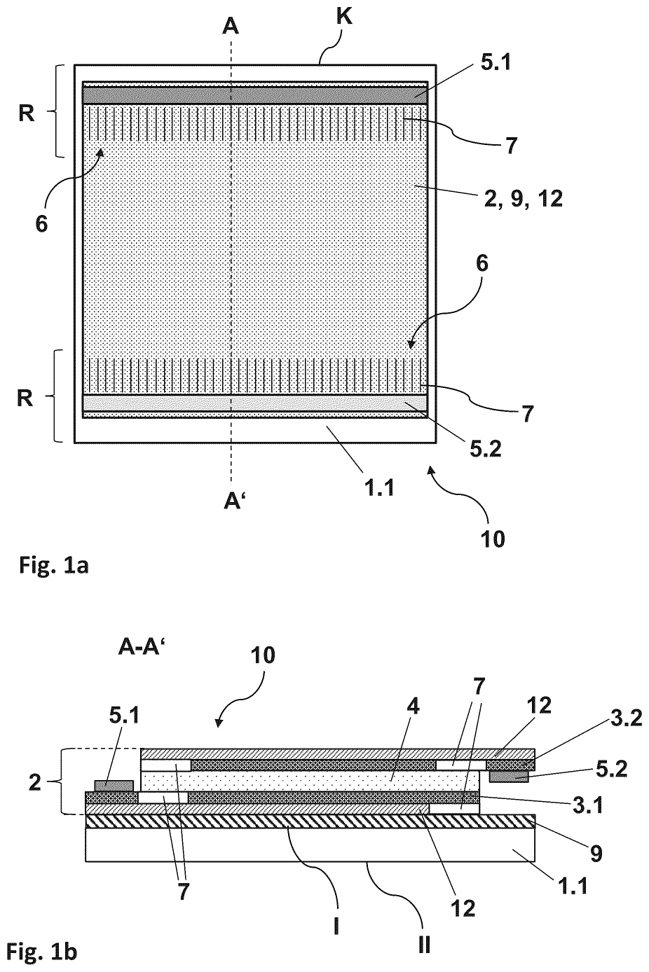

FIG. 1a a schematic representation of a pane according to the invention in plan view,

FIG. 1b a cross-section of the pane according to the invention of FIG. 1a along the section line A-A′,

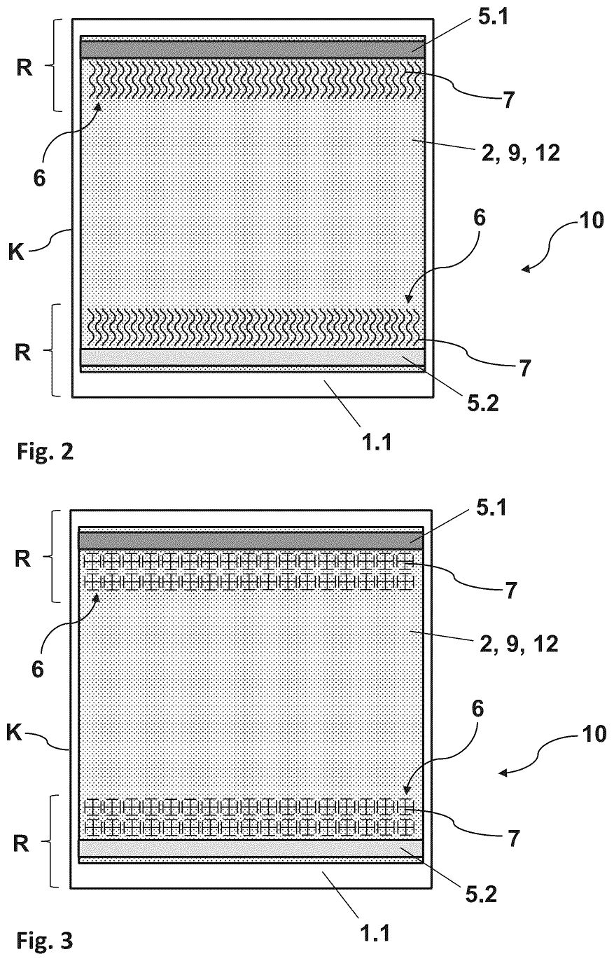

FIG. 2 a schematic representation of another exemplary embodiment of a pane according to the invention in plan view,

FIG. 3 a schematic representation of another exemplary embodiment of a pane according to the invention in plan view,

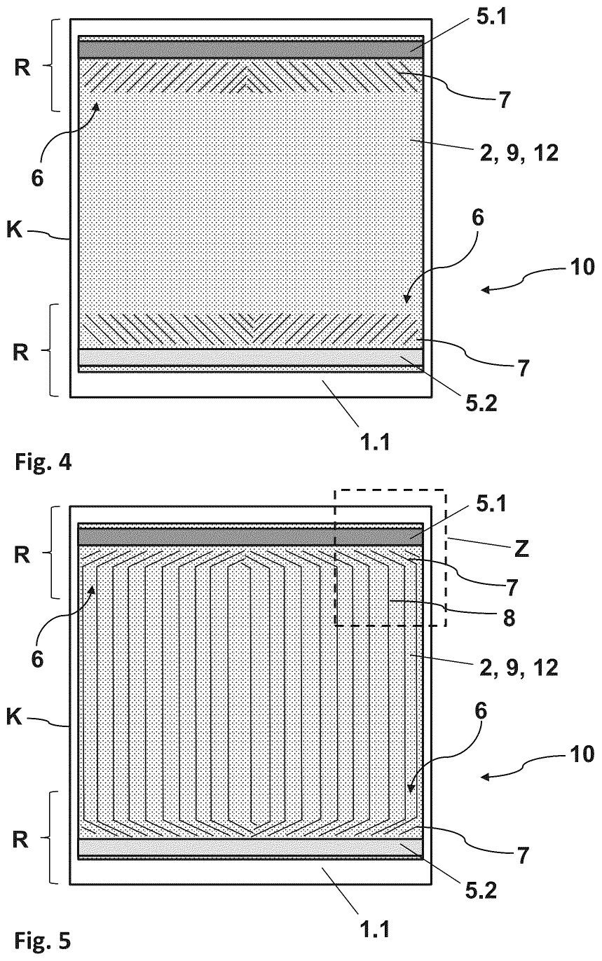

FIG. 4 a schematic representation of another exemplary embodiment of a pane according to the invention in plan view,

FIG. 5 a schematic representation of another exemplary embodiment of a pane according to the invention in plan view,

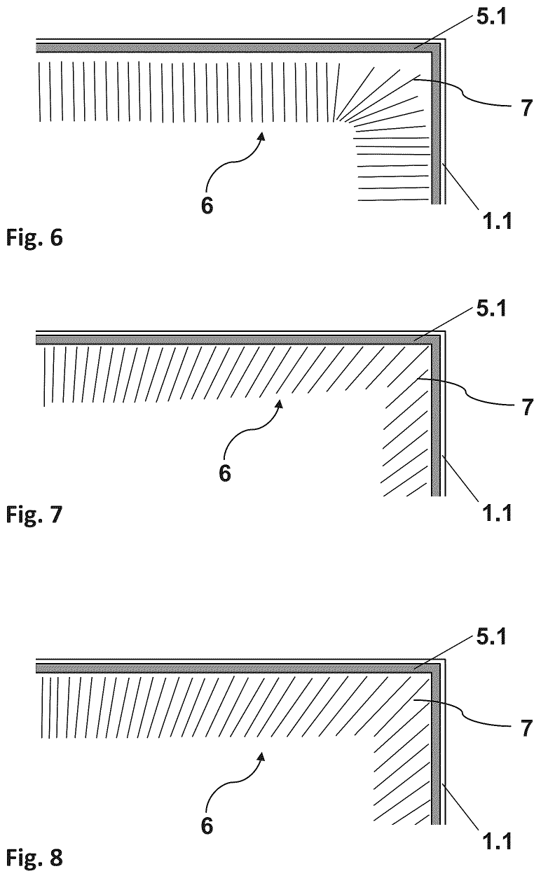

FIG. 6 an alternative embodiment of a pane according to the invention within an enlarged detail Z of FIG. 5,

FIG. 7 an alternative embodiment of a pane according to the invention within an enlarged detail Z of FIG. 5,

FIG. 8 an alternative embodiment of a pane according to the invention within an enlarged detail Z of FIG. 5,

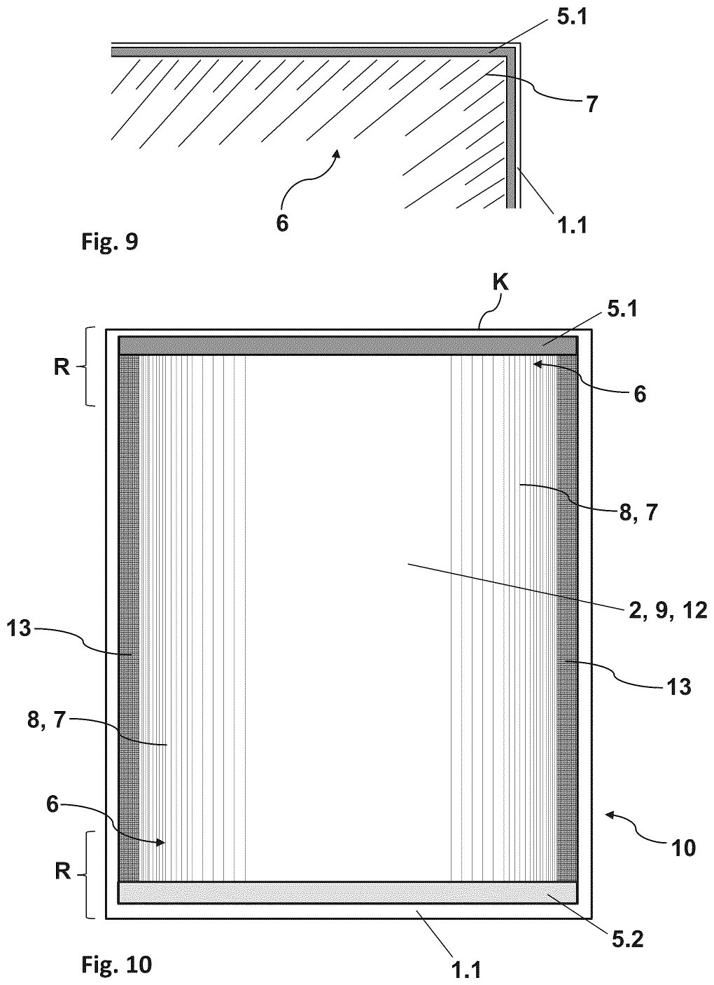

FIG. 9 an alternative embodiment of a pane according to the invention within an enlarged detail Z of FIG. 5,

FIG. 10 a schematic representation of another exemplary embodiment of a pane according to the invention in plan view,

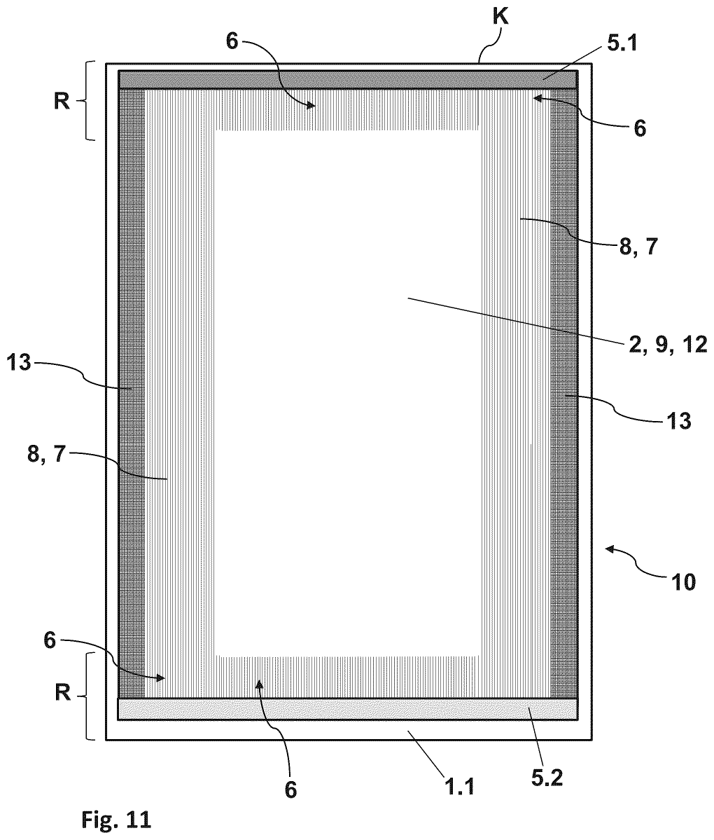

FIG. 11 a schematic representation of another exemplary embodiment of a pane according to the invention in plan view, and

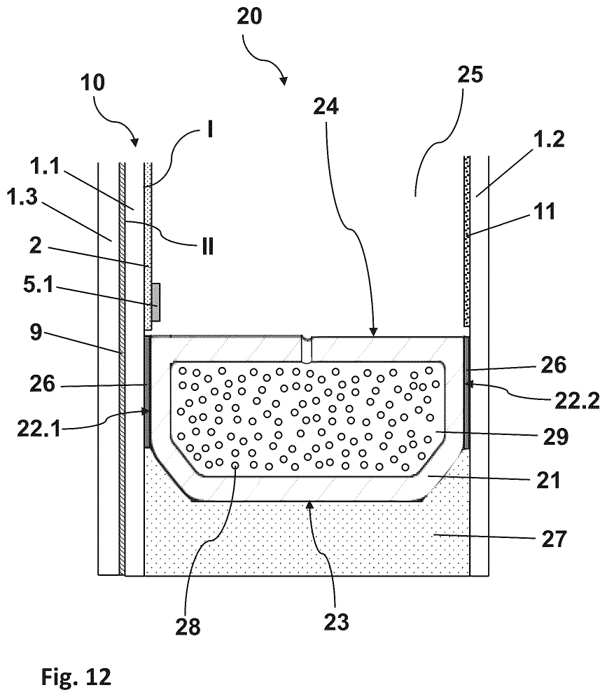

FIG. 12 an insulating glazing according to the invention including a pane according to the invention.

FIG. 1a depicts a schematic representation of a pane 10 according to the invention in plan view. FIG. 1b depicts a cross-section of this pane along the section line AA′. The pane 10 comprises a first pane 1.1, on the first side I of which a functional element 2 is arranged flat. The functional element 2 comprises an electrochromic layer as an active layer 4, which is arranged flat between a first surface electrode 3.1 and a second surface electrode 3.2, with the surface electrodes 3.1, 3.2 being in direct contact with the active layer 4. The first surface electrode 3.1 and the second surface electrode 3.2 are in each case applied to a carrier film 12. The functional element 2 is bonded to the first pane 1.1 by means of a thermoplastic bonding film 9 via the surface of the carrier film 12 facing away from the surface electrode 3.1. Alternatively, the first surface electrode 3.1 nearest the first pane 1.1 can also be applied directly to the first pane 1.1, in which case the thermoplastic bonding film 9 and the carrier film 12 of the first surface electrode 3.1 can be dispensed with. A first busbar 5.1 and a second busbar 5.1 are attached in the edge region R of the pane 10, along two opposing sections of the circumferential edge K, with the first busbar 5.1 electrically conductively contacting the first surface electrode 3.1 and the second busbar 5.2 electrically conductively contacting the second surface electrode 3.2. Applying an electrical voltage to the surface electrodes 3.1, 3.2 via the busbars 5.1, 5.2 induces the switching operation of the active layer 4. In the edge region R, adjacent the first busbar 5.1 and the second busbar 5.2, edge-side patterns 6 are in each case introduced into the first surface electrode 3.1 and the second surface electrode 3.2, respectively. The edge-side patterns 6 are formed by decoated linear regions 7 that extend, starting from the nearest busbar 5.1, 5.2, in the direction of the respective opposite busbars 5.1, 5.2. Depending on the height of the pane, the decoated linear regions 7 have a length of approx. 5% to 30% of the distance between opposite busbars and have a distance of 2.0 mm from the respective adjacent decoated linear region 7. No material of the surface electrodes 3.1, 3.2 is present along the decoated linear regions 7 and this was removed or decomposed, for example, by laser patterning. The edge-side pattern 6 makes the surface electrodes 3.1, 3.2, which are otherwise otherwise impermeable to high-frequency electromagnetic radiation, permeable. The edge-side patterns 6 are, for example, decoated by laser patterning and have only a very small line width of, for example, 0.1 mm. Vision through the pane 10 according to the invention is not significantly impaired and the decoated patterns 6 are hardly detectable. Current paths, along which a flow of current occurs from the busbars 5.1, 5.2 via the surface electrode 3.1, 3.2 associated with the busbar in the direction of the opposite busbar, are formed between adjacent decoated linear regions 7. The edge-side patterns 6 do not enclose any closed areas of the surface electrodes 3.1, 3.2 and the switchability of the functional element 2 is not affected.

FIG. 2 depicts another embodiment of a pane 10 according to the invention. The pane 10 corresponds substantially to the pane 10 of FIG. 1a, wherein, in contrast thereto, the edge-side patterns 6 are formed from wave-shaped decoated linear regions 7. These have a sinusoidal shape. This improves the transmission of electromagnetic radiation whose field vector has components parallel to the preferred direction of the linear regions 7.

FIG. 3 depicts another embodiment of a pane 10 according to the invention. The pane 10 corresponds substantially to the pane 10 of FIG. 1a, with, in contrast thereto, the edge-side patterns 6 having further decoated linear regions 7 that run parallel to the nearest busbar 5.1, 5.2. These linear regions 7 running parallel to the busbar 5.1, 5.2 form a cross-shaped arrangement with the linear regions 7 running in the direction of the opposite busbars 5.1, 5.2. Situated at the ends of the lines forming the cross are further decoated linear regions 7, running in each case perpendicular to the line of the cross-shaped arrangement at the end of which they are attached. The linear regions which, together, have a cross-shaped arrangement, have a length of 25 mm, while the terminal sections of the decoated linear regions 7 have a length of 19 mm. Thus, the cross-shaped arrangements do not form any closed areas. The distance between adjacent cross-shaped arrangements is 2 mm. The edge-side patterns 6 of FIG. 3 have good transmission of electromagnetic radiation of various frequencies, with the switching behavior of the functional element 2 being adversely affected only slightly.

FIG. 4 depicts another embodiment of a pane 10 according to the invention. The pane 10 corresponds substantially to the pane 10 of FIG. 1a, with, in contrast thereto, the linear decoated regions 7 running at an angle of 45° relative to the nearest busbar 5.1, 5.2. In each case, two groups of decoated linear regions 7 are attached to each of the busbars 5.1, 5.2, with the linear regions 7 of a group running parallel to one another in each case. The linear regions 7 of two different groups are at an angle of 90° relative to one another, i.e., differ in terms of their orientation to the busbar in the sign of the magnitude of the angle 45°. The different orientations of the two groups of linear regions 7 are responsible for improved transmission of electromagnetic radiation of different field vectors.

FIG. 5 depicts another embodiment of a pane 10 according to the invention. The pane 10 corresponds substantially to the pane 10 of FIG. 4, with, in contrast thereto, the linear decoated regions 7 of the edge-side pattern 6 running at an angle of 25° relative to the nearest busbar 5.1, 5.2. In addition to this, a central pattern 8 is introduced into the first surface electrode 3.1 and the second surface electrode 3.2. The central pattern 8 comprises linear regions 7 that run perpendicular to the busbars 5.1, 5.2 and connect the edge-side patterns 6 to one another. The central pattern 8 can be attached directly to the decoated regions 7 of the edge-side pattern 6 or can be a small distance from the edge-side pattern 6. Current paths are formed between the edge-side patterns 6 adjacent the first busbar 5.1 and the edge-side patterns 6 adjacent the second busbar 5.2 such that the switching behavior of the functional element is hardly affected. At the same time, transmission of electromagnetic radiation in the through-vision region of the pane 10 can also take place via the central pattern.

FIG. 6 depicts an alternative embodiment of a pane 10 according to the invention within an enlarged detail Z of FIG. 5. In contrast to the pane described in FIG. 5, the pane 10 of FIG. 6 has a first busbar 5.1 that covers two adjacent edge sections of the circumferential edge K arranged at right angles to one another. The second busbar 5.2 (not shown) likewise runs on two adjacent edge sections opposite those of the busbar 5.1. In both edge sections, the decoated linear regions 7 of the edge-side pattern 6 assume an angle of 90° relative to the nearest section of the adjacent busbar 5.1, with a gradual transition between the two orientations of the decoated linear regions 7 occurring in the corner region of the busbar 5.1. The edge-side pattern 6 adjacent the second busbar 5.2 (not shown) is constructed analogously. Due to the large variety of orientations of the decoated linear regions 7, advantageously high transmission of electromagnetic radiation results. Optionally, a central pattern can also be provided in this case, for example, in the form of linear regions that run between the edge-side patterns 6 of the first busbar 5.1 and the second busbar 5.2.

FIG. 7 depicts another alternative embodiment of a pane according to the invention within an enlarged detail Z of FIG. 5. The embodiment of FIG. 7 corresponds substantially to FIG. 6, with, in contrast thereto, there being a slow gradual transition from an arrangement of the decoated linear regions 7 at an angle of 90° relative to the nearest busbar section 2 and orientation at an angle of 45°. An angle of 90° is adopted at the center of the edge, whereas, in the corner regions, an angle of 45° is reached. The length of the decoated linear regions remains substantially constant in order to not increase the processing time of the laser patterning. The higher diversity of the angles of linear regions achieved in FIG. 7 is advantageous in terms of the transmission of different field vectors of electromagnetic radiation.

FIG. 8 depicts another alternative embodiment of a pane according to the invention within an enlarged detail Z of FIG. 5, with this embodiment substantially corresponding to the embodiment of FIG. 7. In contrast thereto, the length of the decoated linear regions 7 increases from the center of the edge to the corner of the pane 10. The edge of the edge-side pattern 6, which is situated at a constant height, can be perceived as more appealing visually.

FIG. 9 depicts another alternative embodiment of a pane according to the invention within an enlarged detail Z of FIG. 5, with the essential features corresponding to the embodiment of FIG. 8. In contrast thereto, the decoated linear regions 7 of FIG. 9 include lines of different length arranged alternatingly. As a result, there is greater line density in the region adjacent the busbar 5.1 than at the edge of the edge-side pattern adjacent the through-vision area. In the region of higher line density, the transmission of higher frequencies is preferred compared to improved transmission of lower frequencies in the region of the edge-side pattern with smaller line density.

FIG. 10 depicts a schematic representation of another exemplary embodiment of a pane according to the invention in plan view. The pane 10 of FIG. 10 corresponds substantially to the pane 10 of FIG. 1a, with the differences being explained below. The edge-side patterns 6 are formed by decoated linear regions 7 that extend, within the first and second surface electrode 3.1, 3.2, starting from the nearest busbar 5.1, 5.2, in the direction of the respective opposite busbar 5.1, 5.2. In the present exemplary embodiment, the linear regions 7 of the edge-side patterns 6 run substantially perpendicular to the busbars 5.1, 5.2 and transition directly into the central pattern 8. The central pattern 8 and the edge-side pattern 6 form, together, mutually parallel decoated lines 7 that run between the first busbar 5.1 and the second busbar 5.2. Current paths are formed between the decoated lines 7. The edge-side pattern 6 and the central pattern 8 do not enclose any closed areas of the surface electrodes 3.1, 3.2, and the switchability of the functional element 2 is not affected. A central pattern 8 is not provided in the entire region of the pane, in particular the center of the surface of the pane 10 is left open to ensure improved through-vision through the pane 10. Also, the distances between adjacent decoated lines 7 within the edge-side pattern 6 and the central pattern 8 increase from the edge sections without busbars in the direction of the center of the pane. As a result, the decoated linear regions 7 become more inconspicuous in the direction of the central through-vision region of the pane. The distance between adjacent decoated lines 7 is from 2 mm to 10 mm. Along the sections of the circumferential edge K, where no busbars are attached, there are electrically isolated zones 13. These electrically isolated zones 13 that are implemented as a grid pattern including areas of the surface electrodes 3.1 and 3.2 enclosed therein are not part of the switchable region of the functional element 2. According to the invention, such closed areas cannot be applied as edge-side patterns along the busbars and are also not formed in the central pattern. Only at the edge sections without busbars can such surface areas be excluded from the switchable functional element 2 without affecting the switching behavior of the rest of the functional element. The embodiment of FIG. 10 is particularly advantageous for achieving good transmission of high-frequency electromagnetic radiation while ensuring good switching behavior of the functional element and good visual appearance.

FIG. 11 depicts a schematic representation of another exemplary embodiment of a pane according to the invention in plan view, with this embodiment substantially corresponding to that described in FIG. 10. In contrast thereto, not all of the decoated linear regions 7 of the edge-side pattern 6 transition into linear decoated regions 7 of the central pattern 8. In the region of the central through-vision region of the pane 10, there is no central pattern 8, but there is an edge-side pattern 6. The distance between adjacent decoated linear regions 7 of the edge-side pattern 6 and the central pattern 8 is 2 mm. This embodiment also has particularly good transmission of high-frequency electromagnetic radiation with good switching behavior of the functional element and good visual appearance.

FIG. 12 depicts an insulating glazing 20 according to the invention including a pane 10 according to the invention. An electrochromic functional element 2 is attached to the first pane 1.1, and an electrically conductive coating 11 is applied to a second pane 1.2. The electrically conductive coating 11 is infrared reflecting. The first pane 1.1 is assembled on the surface facing away from the functional element 2 by means of a thermoplastic intermediate layer 9 with a third pane 1.3 to form the pane 10 in the form of a composite pane. The pane 10 and the second pane 1.2 are joined via the spacer 21 to form the insulating glazing 20. The spacer 21 is attached circumferentially between the first pane 1.1 and the second pane 1.2 via a sealant 26. The sealant 26 connects the pane contact surfaces 22.1 and 22.2 of the spacer 21 to the panes 1.1 and 1.2. The spacer 21 is implemented as a polymeric main body with a cavity 29. A gas- and water-tight barrier film (not shown) is applied on the outer surface 23 of the spacer 21. The cavity 29 contains a desiccant 28 that can absorb the residual moisture from the glazing interior 25 via openings in the glazing interior surface 24. The glazing interior 25 adjacent the glazing interior surface 24 of the spacer 21 is defined as the space delimited by the panes 1.1, 1.2 and the spacer 21. The outer interpane space adjacent the outer surface 23 of the spacer 21 is a strip-shaped circumferential section of the glazing that is delimited on one side each by the two panes 1.1, 1.2 and by the spacer 21 on another side and whose fourth edge is open. The glazing interior 25 is filled with argon. A sealant 26 that seals the gap between pane 1.1, 1.2 and spacer 21 is introduced in each case between a pane contact surface 22.1 or 22.2 and the adjacent pane 1.1 or 1.2, respectively. The sealant 26 is polyisobutylene. An outer seal 27 that serves to bond the first pane 1.1 and the second pane 1.2 is placed on the outer surface 23 in the outer interpane space. The outer seal 27 is made of silicone. The outer seal 27 ends flush with the pane edges of the first pane 1.1 and the second pane 1.2. The second pane 1.2 has a thickness of 4.0 mm and has an infrared reflecting coating 11 on the pane surface facing the glazing interior 25. The electrochromic functional element 2, which is equipped with a first busbar 5.1 for the electrical contacting of the functional element 2, is attached on the pane surface I of the first pane 1.1 facing the glazing interior 25. The second busbar is not shown in this view. The busbars 5.1, 5.2 were produced by printing a conductive paste and electrically contacted on the electrochromic functional element 2. The conductive paste, also referred to as silver paste, contains silver particles and glass frits. The busbars run on the first pane 1.1 in the glazing interior 25 and parallel to the glazing interior surface 24 of the spacer 21. The first pane 1.1 has a thickness of 2.0 mm and is laminated via a thermoplastic bonding film 9 made of 0.76-mm PVB with a third pane 1.3 with a thickness of 2.0 mm. The composite pane 10 comprising the first p top ane 1.1 and the third pane 1.3 constitutes the outer pane of a building glazing, while the second pane 1.2 is the inner pane. The insulating glazing 20 according to the invention has good heat dissipation from the electrochromic functional element 2 and good thermal insulation of the building interior due to the infrared reflecting coating 11. The functional element 2 is designed as shown in FIG. 5, with the first and the second surface electrode 3.1, 3.2 being equipped with edge-side patterns 6 and central patterns 8 as shown in FIG. 5. The electrically conductive coating 11 of the second pane acting as an infrared reflecting coating is also provided with the edge-side patterns and central patterns 6, 8 explained in FIG. 5.

### LIST OF REFERENCE CHARACTERS

10 pane
1.1 first pane
1.2 second pane
1.3 third pane
2 functional element having electrically switchable optical properties
3 surface electrodes
3.1 first surface electrode
3.2 second surface electrode
4 active layer
5 busbars
5.1 first busbar
5.2 second busbar
6 edge-side pattern
7 linear regions
8 central pattern
9 thermoplastic intermediate layer
11 electrically conductive coating
12 carrier films
13 electrically isolated zones
20 insulating glazing
21 spacer
22 pane contact surfaces
22.1 first pane contact surface
22.2 second pane contact surface
23 outer side of the spacer
24 glazing interior surface of the spacer
25 glazing interior
26 sealant
27 outer seal
28 desiccant
29 cavity
I first side
II second side
K circumferential edge
R edge region

1. A pane with a functional element having electrically switchable optical properties, comprising:
at least one first pane having a first side, a second side, and an edge region adjacent a circumferential edge,
at least one functional element having electrically switchable optical properties that is arranged flat on the first side of the first pane, at least comprising a first surface electrode, an active layer, and a second surface electrode arranged flat one above the other in this order,
at least one first busbar that electrically conductively contacts the first surface electrode and at least one second busbar that electrically conductively contacts the second surface electrode,
at least one edge-side pattern in the edge region that is formed by decoated linear regions within the first surface electrode and/or the second surface electrode such that the decoated linear regions are situated adjacent along the first busbar and/or the second busbar and extend, starting from there, in a direction of an opposite section of the circumferential edge,
wherein the edge-side pattern has no electrically isolated zones within the first surface electrode and the second surface electrode.

2. The pane according to claim 1, wherein the at least one first busbar and the at least one second busbar are arranged on opposite sections of the circumferential edge.

3. The pane according to claim 1, wherein the decoated linear regions have a wavy shape or substantially wavy shape.

4. The pane according to claim 1, wherein the decoated linear regions of the edge-side pattern have a rectilinear course or a substantially rectilinear course.

5. The pane according to claim 4, wherein the decoated linear regions have an angle of 10° to 50° relative to the adjacent first busbar or second busbar.

6. The pane according to claim 1, wherein the decoated linear regions of the edge-side pattern have increased line density in a direction of the circumferential edge.

7. The pane according to claim 1, wherein the first surface electrode and/or the second surface electrode has a group of decoated linear regions that are parallel or substantially parallel to decoated linear regions of the same.

8. The pane according to claim 1, wherein the first surface electrode and/or the second surface electrode has at least one central pattern that is introduced at least partially in regions outside the edge region and wherein the central pattern has no electrically isolated zones within the first surface electrode and the second surface electrode.

9. The pane according to claim 8, wherein the central pattern has decoated linear regions that extend within the first surface electrode starting from the edge-side pattern in the vicinity of the first busbar in a direction of the second busbar and/or extend within the second surface electrode starting from the edge-side pattern in the vicinity of the second busbar in the direction of the first busbars.

10. The pane according to claim 1, wherein along the sections of the circumferential edge on which no busbars are arranged, electrically isolated zones are introduced in the edge region within the first surface electrode and/or the second surface electrode.

11. The pane according to claim 1, wherein the functional element is an electrochromic functional element, an SPD element, a PDLC element, or an electroluminescent element.

12. An insulating glazing at least comprising:
a pane according to claim 1,
a second pane at least including an electrically conductive coating,
a circumferential spacer that joins the second pane to the pane, wherein at least one edge-side pattern is introduced into the electrically conductive coating in the edge region.

13. A method for producing a pane according to claim 1, comprising:
a. providing a first pane with a functional element having electrically switchable optical properties, and
b. forming at least one edge-side pattern comprising decoated linear regions within the first surface electrode and/or the second surface electrode such that the decoated linear regions are situated adjacent the first busbar and/or second busbar and extend, starting from there, in a direction of the opposite section of the circumferential edge,
wherein the edge-side pattern has no electrically isolated zones within the first surface electrode and the second surface electrode.

14. The method for producing a pane according to claim 12, wherein the edge-side pattern is introduced by laser patterning.

15. A method comprising providing a pane according to claim 1 in a vehicle body or a vehicle door of a vehicle of transport on land, on water, or in the air, or in a building as part of an external façade or a building window.

16. The pane according to claim 3, wherein the decoated linear regions have a sinusoidal course at least in some sections and/or a zigzag course at least in some sections.

17. The pane according to claim 5, wherein the decoated linear regions have an angle of 20° to 45° relative to the adjacent first busbar or second busbar.

18. The pane according to claim 7, wherein a distance between adjacent decoated regions of the same group is 1.0 mm to 20.0 mm.

19. The pane according to claim 7, wherein a distance between adjacent decoated regions of the same group is 2.0 mm to 5.0 mm.

20. A method comprising providing an insulating glazing according to claim 12 as glazing with low transmission loss for high-frequency electromagnetic radiation, in a vehicle body or a vehicle door of a vehicle of transport on land, on water, or in the air or in a building as part of an external façade or a building window
